(19) United States
(12) Patent Application Publication
(10) Pub. No.: US 2016/0362145 A1
(43) Pub. Date: Dec. 15, 2016

(54) MOUNTING ARRANGEMENT FOR COUPLING WORK TOOL ATTACHMENT WITH MACHINE

(71) Applicant: Caterpillar Inc., Peoria, IL (US)

(72) Inventor: Karl S. Kuriger, Raleigh, NC (US)

(73) Assignee: Caterpillar Inc., Peoria, IL (US)

(21) Appl. No.: 15/244,550

(22) Filed: Aug. 23, 2016

(51) Int. Cl. B62D 49/06

(52) U.S. Cl. CPC B62D 49/065; B62D 49/06; A01B 59/066

(57) ABSTRACT

The disclosure relates to a mounting arrangement for coupling a work tool attachment with a three-point linkage of a machine. The mounting arrangement includes a mounting portion, a pair of support plates having holes, and a connecting rod removably received through the holes of the pair of supporting plates. The mounting arrangement includes an attachment bracket adapted to couple to the mounting portion. The attachment bracket includes a first plate and a second end distal to the first end. The first end defines a first opening and the second end defines a plurality of first through-holes. The attachment bracket includes a second plate having a first end and a second end distal to the first end. The first end defines a second opening and the second end defining a plurality of second through-holes. The attachment bracket includes a hollow shaft adapted to slidably receive the connecting rod therethrough.

### TECHNICAL FIELD

The present disclosure relates to a mounting arrangement for a work tool attachment, and more particularly relates to an attachment bracket of the mounting arrangement for coupling the work tool attachment with a machine.

### BACKGROUND

Machines, such as tractors, are used for hauling a trailer or machinery used in agriculture or construction. Generally, tractors include a three-point linkage for attaching a work tool to the tractor. In cases where a work tool needs to be coupled with the three-point linkage of the machine, a work tool attachment having three mounting locations is employed to aid in coupling of the work tool with the tractor. In an example, the work tool attachment used for coupling a work tool with a Skid Steer Loader (SSL) cannot be used for coupling the same work tool with the three-point linkage of the tractor. Developing such work tool attachment suitable for various work tools may cause increase in development cost and inventory cost. Further, developing individual work tool attachment for various work tools may cause undue burden on customer, in terms of cost, transportation, and maintenance.

U.S. Pat. No. 7,226,268, hereinafter referred to as the '268 patent, describes a faceplate having a set of skid steer receiver attachment points to permit an all-purpose agricultural tractor with a three-point hitch. The '268 patent further describes the faceplate includes a front end loader to operably connect to off-the-shelf skid steer attachments so that the agricultural tractor can utilize off-the-shelf skid steer attachments with the faceplate. The faceplate includes a cylindrical housing to permit rotation of a tool mounted therein without removing the tool from the faceplate. The faceplate further includes a notched chain bar having notches extending generally normal to the hitch faceplate and a further embodiment including a universal tractor mount. However, the '268 patent fails to disclose a work tool attachment, which is less complex to design and aid in coupling a work tool with a machine.

### SUMMARY OF THE DISCLOSURE

In one aspect of the present disclosure, a mounting arrangement for coupling a work tool attachment with a three-point linkage of a machine is provided. The work tool attachment includes an elongated base portion adapted to couple to a work tool of the machine. The mounting arrangement includes a mounting portion located between a first end and a second end of the elongated base portion. The mounting portion includes a pair of support plates having holes, and a connecting rod removably received through the holes of the pair of supporting plates. The mounting arrangement further includes an attachment bracket adapted to couple to the mounting portion. The attachment bracket includes a first plate having a first end and a second end distal to the first end. The first end defines a first opening and the second end defines a plurality of first through-holes. At least one of the plurality of first through-holes removably receives a pin therethrough. The attachment bracket further includes a second plate having a first end and a second end distal to the first end. The first end defines a second opening and the second end defining a plurality of second through-holes. At least one of the plurality of second through-holes removably receives the pin therethrough. The pin is adapted to couple to a top link of the three-point linkage of the machine. The attachment bracket further includes a hollow shaft having a first end coupled with the first opening of the first plate and a second end coupled with the second opening of the second plate. The hollow shaft is adapted to slidably receive the connecting rod therethrough. The attachment bracket is disposed between the pair of support plates and removably coupled with the connecting rod.

In another aspect of the present disclosure, an attachment bracket for coupling a mounting portion of a work tool attachment with a machine is provided. The attachment bracket includes a first plate having a first end and a second end distal to the first end. The first end defines a first opening and the second end defines a plurality of first through-holes. At least one of the plurality of first through-holes removably receives a pin therethrough. The attachment bracket further includes a second plate having a first end and a second end distal to the first end. The first end defines a second opening and the second end defining a plurality of second through-holes. At least one of the plurality of second through-holes removably receives the pin therethrough. The pin is adapted to couple to a top link of the three-point linkage of a machine. The attachment bracket further includes a hollow shaft having a first end coupled with the first opening of the first plate and a second end coupled with the second opening of the second plate. The hollow shaft is adapted to slidably receive the connecting rod therethrough The attachment bracket is disposed between a pair of support plates and removably coupled with the connecting rod.

Other features and aspects of this disclosure will be apparent from the following description and the accompanying drawings.

### BRIEF DESCRIPTION OF THE DRAWINGS

FIG. 1 is a perspective view of a machine having a work tool attachment coupled to a three-point linkage of the machine;

FIG. 2 is a perspective view of the work tool attachment of FIG. 1 having a mounting arrangement used for coupling the work tool attachment with the three-point linkage of the machine;

FIG. 3 is an exploded view showing coupling of an attachment bracket of the mounting arrangement of FIG. 2 with a mounting portion of the work tool attachment; and

FIG. 4 is a perspective view of the attachment bracket of the mounting arrangement of FIG. 2.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in singular may also be construed to relate to the plural and vice-versa without limiting the scope of the disclosure to the exact number or type of such elements unless set forth explicitly in the appended claim.

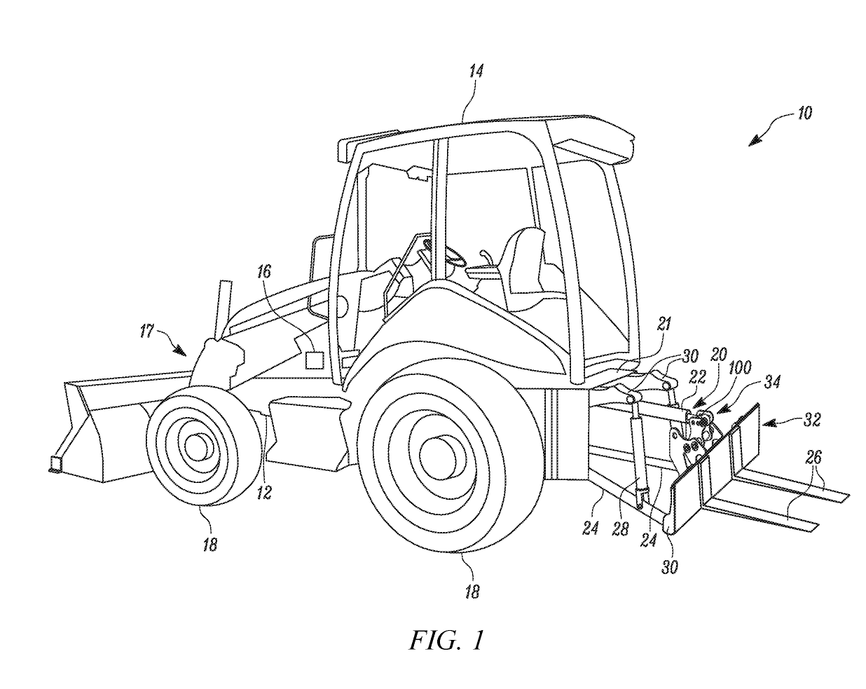

Referring to FIG. 1, a perspective view of a machine 10, such as a tractor, is illustrated. The machine 10 is used for hauling a trailer or machinery that is used in agriculture or construction field. In an example, the machine 10 may be any machine having a three-point linkage used in various industries including, but not limited to, agriculture, transportation, construction, and material handling. The machine 10 includes a chassis 12 and an operator cabin 14 mounted on the chassis 12. The machine 10 further includes an engine 16 disposed on the chassis 12 at a front end 17 thereof. The engine 16 is used for providing power to various operating systems, such as a hydraulic system and a transmission system of the machine 10. A set of ground engaging members 18 is supported to the chassis 12 for propelling the machine 10 over a around surface. The operator cabin 14 houses various control systems for controlling operations of the hydraulic system and the transmission system of the machine 10.

The machine 10 further includes a three-point linkage 20 attached to a rear end 21 of the chassis 12 of the machine 10. In an example, the three-point linkage 20 of the machine 10 may be a hitch used for attaching a work tool 26, such as a forklift, to the machine 10. In other examples, the work tool 26 may be a bucket, a plough, or any other work tool used in agriculture and construction field. The work tool 26 is used for performing various operations including, but not limited to, transporting of material within a worksite. The three-point linkage 20 includes a top link 22 and a pair of lower links 24. One end of each of the pair of lower links 24 is pivotally coupled to the chassis 12. Each of the pair of lower links 24 is further coupled to a pair of arms 28, by a connecting rod 30. The pair of arms 28 is actuated by the hydraulic system of the machine 10. Based on an input from an operator of the machine 10 and upon actuation by the hydraulic system, the pair of arms 28 raises or lowers the pair of lower links 24. Actuation of the three-point linkage 20 is controlled by the operator using the various control systems provided in the operator cabin 14. Further, one end of the top link 22 is pivotally coupled to the chassis 12 using a mechanical sensor (not shown), which in turn communicates with the hydraulic system using sensing linkages (not shown). The top link 22 facilitates upward movement of the work tool 26, when the work tool 26 is engaged with the ground surface and exposed to undesirable load during operation of the machine 10. Other ends of each of the top link 22, and the pair of lower links 24 is pivotally attached to a work tool attachment 32 for enabling coupling of the work tool 26 with the three-point linkage 20. The work tool attachment 32 is removably coupled to the three-point linkage 20 by a mounting arrangement 34.

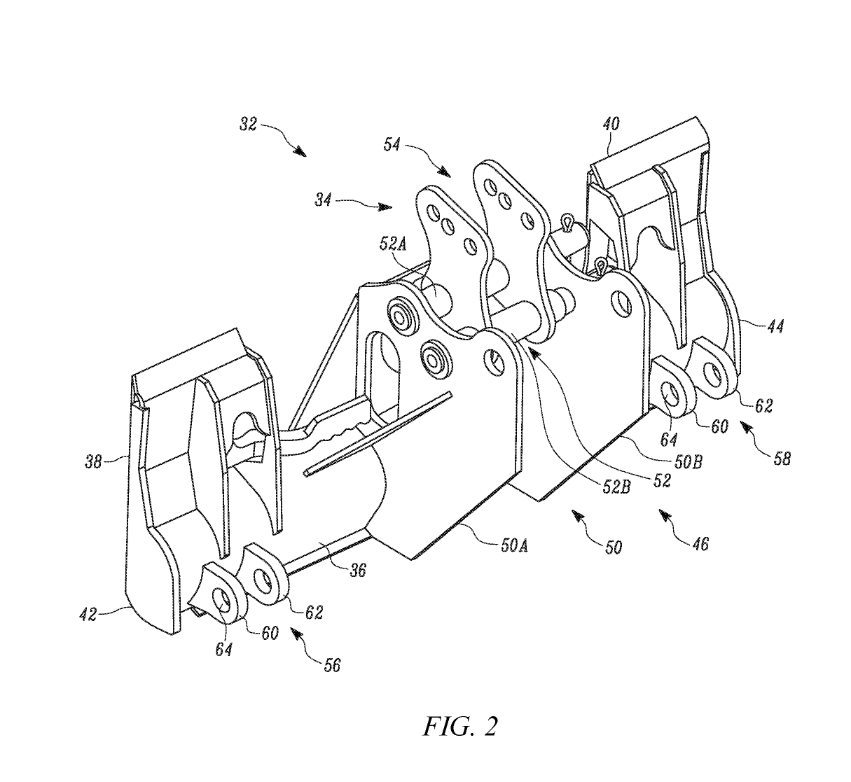

Referring to FIG. 2, a perspective view of the work tool attachment 32 having the mounting arrangement 34 is illustrated. The work tool attachment 32 includes an elongated base portion 36 that serves as an interface for coupling the work tool 26 to the three-point linkage 20 of the machine 10. The elongated base portion 36 includes a first extension member 38 and a second extension member 40 located at a first end 42 and a second end 44, respectively. The first extension member 38 and the second extension member 40 extend from the elongated base portion 36 for coupling with the work tool 26 of the machine 10. In an example, the first extension member 38 and the second extension member 40 may be manufactured as individual components and may be attached to the elongated base portion 36 either through fasteners, such as bolts and nuts, or by welding.

The mounting arrangement 34 includes a mounting portion 46 located between the first end 42 and the second end 44 of the elongated base portion 36. Specifically, the mounting portion 46 is located midway between the first end 42 and the second end 44 of the elongated base portion 36. The mounting portion 46 is an integral component of the work tool attachment 32 that assists coupling of the work tool attachment 32 with the three-point linkage 20 of the machine 10. The mounting portion 46 includes a pair of support plates 50, individually referred to as a first support plate 50A and a second support plate 50B, and a pair of connecting rods 52, individually referred to as a first connecting rod 52A and a second connecting rod 52B, connected between the pair of support plates 50. The mounting arrangement 34 further includes an attachment bracket 54 coupled to the mounting portion 46 for coupling with the top link 22 of the three-point linkage 20.

The mounting arrangement 34 also includes a first mounting member 56 attached to the first end 42 of the elongated base portion 36 and a second mounting member 58 attached to the second end 44 of the elongated base portion 36. The first mounting member 56 and the second mounting member 58 are used for coupling with each of the pair of lower links 24. Each of the first and second mounting members 56, 58 includes a first bracket 60 and a second bracket 62. The first and second brackets 60, 62 are welded to the elongated base portion 36. Each of the first and second brackets 60, 62 includes a hole, such as hole 64 and 65, respectively, for removably receiving a pin (not shown) therethrough. The first and second brackets 60, 62 of each of the first and second mounting member 56, 58 are used for coupling each of the pair of lower links 24 by using the pin. Thus, coupling of the top link 22 with the attachment bracket 54, and coupling of the first mounting member 56 and the second mounting member 58 with the pair of lower links 24 facilitate coupling of the work tool attachment 32 with the three-point linkage 20 of the machine 10.

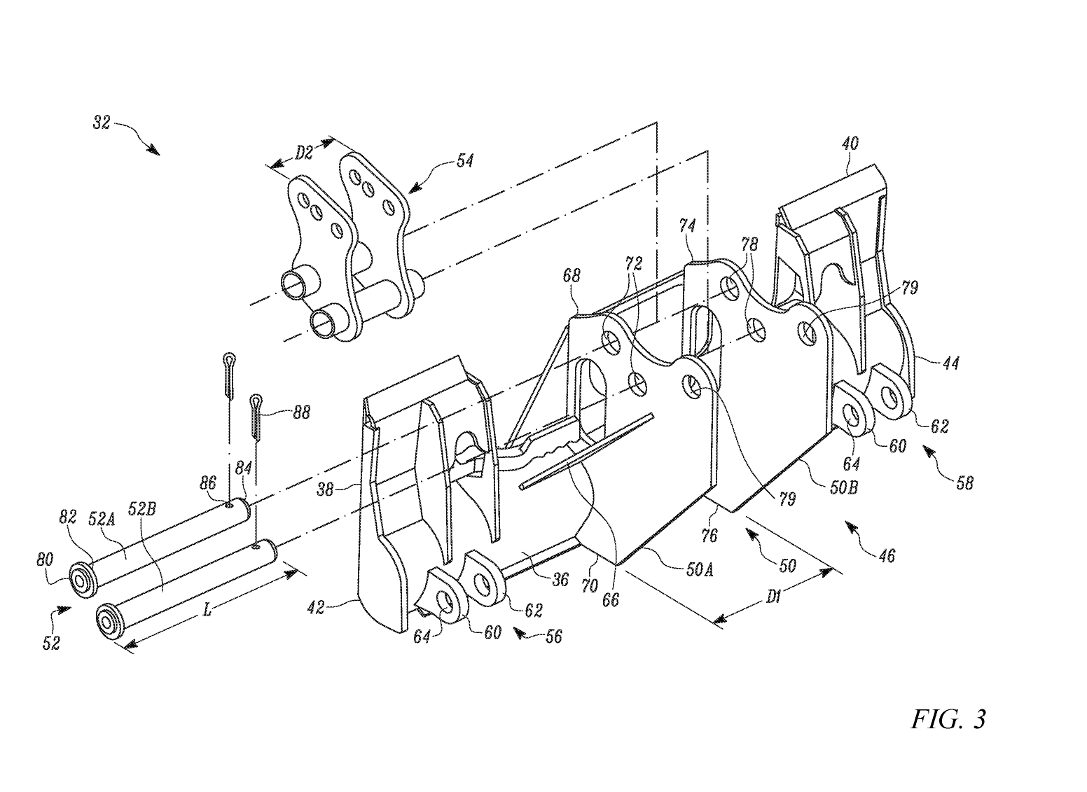

Referring to FIG. 3, coupling of the attachment bracket 54 of the mounting arrangement 34 with the mounting portion 46 of the work tool attachment 32 is illustrated. As described earlier, the mounting portion 46 is located between the first end 42 and the second end 44 of the elongated base portion 36, and includes the first support plate 50A and the second support plate 508 coupled to the elongated base portion 36. The first support plate 50A and the second support plate 50B are spaced apart by a first distance ‘D1’. The first support plate 50A and the second support plate 50B are welded to the elongated base portion 36, and extend vertically and perpendicularly from the elongated base portion 36, as shown in FIG. 3. Multiple supporting members, such as a supporting member 66, are welded between the elongated base portion 36, and each of the pair of support plates 50 to provide structural rigidity to the pair of support plates 50.

The first support plate 50A includes a first end 68, a second end 70, and a pair of holes 72 defined at the first end 68. Similarly, the second support plate 50B includes a first end 74, a second end 76, and a pair of holes 78 defined at the first end 74. Each of the pair of holes 72 of the first support plate 50A is coaxial with each of the pair of holes 78 of the second support plate 50B. The first connecting rod 52A and the second connecting rod 52B are removably received through the pair of holes 72 and 78 of each of the first and second support plates 50A, 50B, respectively. In addition to the pair of holes 72 and 78, each of the first support plate 50A and the second support plate 50B can include another hole 79, as shown in FIG. 3. The attachment bracket 54 is removably coupled to the mounting portion 46 using the first and second connecting rods 52A, 52B. Although the mounting portion 46 includes the pair of connecting rods 52 for coupling with the attachment bracket 54 in the illustrated embodiment, it should be understood that the attachment bracket 54 is coupled to the mounting portion 46 using one of the first and second connecting rods 52A, 528. For instance, in an example, the first and second connecting rods 52A, 52B can be replaced with a single connecting rod for coupling the attachment bracket 54 at the mounting portion 46.

The first connecting rod 52A includes a first end 80 having ahead portion 82 and a second end 84 defining a cross hole 86. The cross hole 86 slidably receives a cotter pin 88 therethrough. The connecting rod 52 has a length greater than the first distance ‘D1’ between the first and second support plates 50A, 50B. As such, in an engaged condition of the first connecting rod 52A with each of the first and second support plates 50A, 50B, the second end 84 of the first connecting rod 52A extends beyond the second support plate 50B, as shown in FIG. 3. The cotter pin 88 is further inserted through the cross hole 86 to lock the first connecting rod 52A with the first and second support plates 50A, 50B. The second connecting rod 52B would also have similar configuration as that of the first connecting rod 52A. Thus, the attachment bracket 54 is removably coupled to the first support plate 50A and the second support plate 50B via the connecting rod 52.

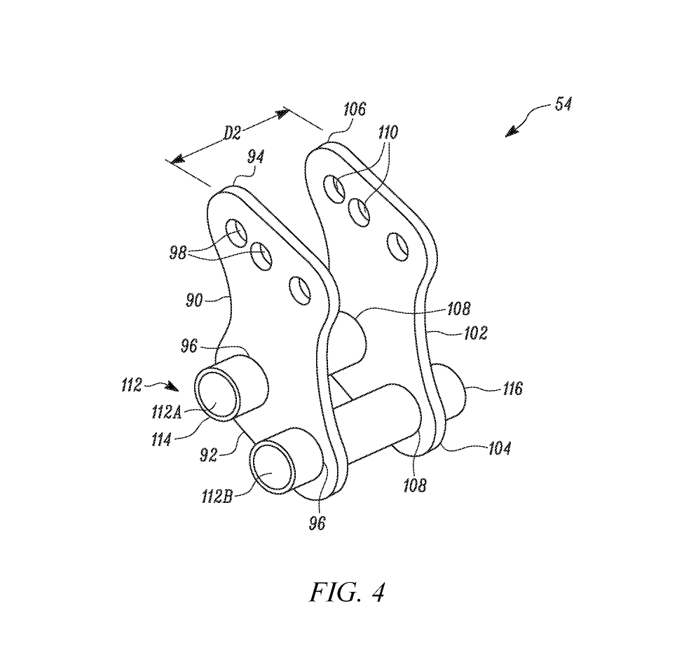

Referring to FIG. 4, a perspective view of the attachment bracket 54 is illustrated. The attachment bracket 54 includes a first plate 90 having a first end 92 and a second end 94. The first end 92 of the first plate 90 defines a pair of first openings 96 and the second end 94 of the first plate 90 defines a plurality of first through-holes 98. At least one of the plurality of first through-holes 98 removably receives a pin 100 (as shown in FIG. 1) therethrough. Similarly, the attachment bracket 54 further includes a second plate 102 having a first end 104 and a second end 106. The first end 104 of the second plate 102 defines a pair of second openings 108 and the second end 106 of the second plate 102 defines a plurality of second through-holes 110. At least one of the plurality of second through-holes 110 removably receives the pin 100 therethrough. In the illustrated example, each of the second end 94 of the first plate 90 and the second end 106 of the second plate 102 includes three first through-holes 98 and three second through-holes 110, respectively.

The attachment bracket 54 further includes a pair of hollow shafts 112, individually referred to as a first hollow shaft 112A and a second hollow shaft 112B, coupled between the first plate 90 and the second plate 102. The pair of hollow shafts 112 is coupled with the pair of first openings 96 of the first plate 90 and the pair of second openings 108 of the second plate 102. The first plate 90 and the second plate 102 are separated by a second distance ‘D2’, as shown in FIG. 4. The second distance ‘D2’ between the first plate 90 and the second plate 102 is smaller than the first distance ‘D1’ defined between the pair of support plates 50. As such, the attachment bracket 54 is received between the pair of support plates 50. In addition, the second distance ‘D2’ between the first plate 90 and the second plate 102 is predetermined to be capable of receiving the top link 22 of the three-point linkage 20. Further, the pin 100 is received through the first through-hole 98 of the first plate 90 and the second through-hole 110 of the second plate 102 aids in coupling of the top link 22 with the attachment bracket 54.

The first hollow shaft 112A includes a first end 114 and a second end 116. The first end 114 is coupled with one first opening of the pair of first openings 96 of the first plate 90 and the second end 116 is coupled with one second opening of the pair of second openings 108 of the second plate 102. The first hollow shaft 112A is welded to the first plate 90 and the second plate 102. The first hollow shaft 112A has an inner diameter greater than an outer diameter of the connecting rod 52, such that the first connecting rod 52A is slidably received through the first hollow shaft 112A. Likewise, the second hollow shaft 112B can be welded to the first plate 90 and the second plate 102. Further, the second connecting rod 52B can be slidably received through the second hollow shaft 112B. As described earlier, the attachment bracket 54 is coupled to the pair of support plates 50 of the mounting portion 46. The attachment bracket 54 is disposed between the pair of support plates 50 and is removably coupled with the pair of connecting rods 52. In cases where the single connecting rod is employed to couple the attachment bracket 54 between the pair of support plates 50, it will be understood that the attachment bracket 54 can include a single shaft to receive the single connecting rod therethrough.

### INDUSTRIAL APPLICABILITY

The present disclosure relates to the mounting arrangement 34 for coupling the work tool attachment 32 with the three-point linkage 20 of the machine 10. The attachment bracket 54 of the mounting arrangement 34, according to the present disclosure, is disposed between the pair of support plates 50. More specifically, the attachment bracket 54 is removably coupled with the pair of connecting rods 52 of the mounting portion 46. During assembly of the attachment bracket 54 with the mounting portion 46, the pair of connecting rods 52 is removed from the pair of holes 72 and 78 of the first support plate 50A and the second support plate 50B, respectively. Upon removing the pair of connecting rods 52, the attachment bracket 54 is disposed between the first support plate 50A and the second support plate 50B of the mounting portion 46. Further, the pair of hollow shafts 112 of the attachment bracket 54 is aligned coaxial with the pair of holes 72 and 78 of the first and second support plates 50A, 50B, respectively. The second end 84 of each of the pair of connecting rods 52 is further inserted through the respective holes 72 of the first support plate 50A, the hollow shaft 112, and the holes 78 of the second support plate 50B. The cotter pin 88 is further inserted through the cross hole 86 of each of the pair of connecting rods 52 when the respective connecting rods 52 extend from the second support plate 50B. Thus the attachment bracket 54 is removably coupled to the mounting portion 46 of the work tool attachment 32, thereby facilitating coupling of the work tool attachment 32 with the three-point linkage 20 of the machine 10.

When the work tool attachment 32 is to be used with other machines, such as an excavator having a boom assembly, a loader with arms for carrying implements, and a skid steer loader, the attachment bracket 54 is removed from the mounting portion 46 and the work tool attachment 32 is directly installed on such machines by the operator with less effort. Thus, the attachment bracket 54 of the present disclosure provides flexibility to the work tool attachment 32 to couple with any type of machines with less or no modification. Less development cost is incurred in the development of the attachment bracket 54 as compared to developing a work tool attachment having an integral mounting member for coupling with the top link 22 of the three-point linkage 20. Further, inventory cost is reduced as only the attachment bracket 54 is procured and stored instead of storing a separate work tool attachment. The work tool attachment 32 can also be used as a standard coupling attachment for coupling various types of work tool attachments and various work tools with the three-point linkage 20 of the machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting arrangement for coupling a work tool attachment with a three-point linkage of a machine, the work tool attachment including an elongated base portion adapted to couple to a work tool of the machine, the mounting arrangement comprising:
a mounting portion located between a first end and a second end of the elongated base portion, the mounting portion including a pair of support plates having holes, and a connecting rod removably received through the holes of the pair of supporting plates; and
an attachment bracket adapted to couple to the mounting portion, the attachment bracket including:
a first plate having a first end and a second end distal to the first end, the first end defining a first opening and the second end defining a plurality of first through-holes, wherein at least one of the plurality of first through-holes removably receives a pin therethrough;
a second plate having a first end and a second end distal to the first end, the first end defining a second opening and the second end defining a plurality of second through-holes, wherein at least one of the plurality of second through-holes removably receives the pin therethrough, wherein the pin is adapted to couple to a top link of the three-point linkage of the machine; and
a hollow shaft having a first end coupled with the first opening of the first plate and a second end coupled with the second opening of the second plate, the hollow shaft adapted to slidably receive the connecting rod therethrough,
wherein the attachment bracket is disposed between the pair of support plates and removably coupled with the connecting rod.

2. The mounting arrangement of claim 1 further comprising:
a first mounting member extending from the first end of the elongated base portion; and
a second mounting member extending from the second end of the elongated base portion,
wherein the first mounting member and the second mounting member are adapted to couple with a pair of lower links of the three-point linkage of the machine.

3. An attachment bracket for coupling a mounting portion of a work tool attachment with a machine, the attachment bracket comprising:
a first plate having a first end and a second end distal to the first end, the first end defining a first opening and the second end defining a plurality of first through-holes, wherein at least one of the plurality of first through-holes removably receives a pin therethrough;
a second plate having a first end and a second end distal to the first end, the first end defining a second opening and the second end defining a plurality of second through-holes, wherein at least one of the plurality of second through-holes removably receives the pin therethrough wherein the pin is adapted to couple to a top link of a three-point linkage of a machine; and
a hollow shaft having a first end coupled with the first opening of the first plate and a second end coupled with the second opening of the second plate, the hollow shaft adapted to slidably receive a connecting rod therethrough,
wherein the attachment bracket is disposed between a pair of support plates of the mounting portion and removably coupled with the connecting rod.
